(19) United States
(12) Patent Application Publication
(10) Pub. No.: US 2016/0088858 A1
(43) Pub. Date: Mar. 31, 2016

(54) S'MORE WRAP FOOD PRODUCT

(71) Applicant: Gary Kraeger, Wind Lake, WI (US)

(72) Inventor: Gary Kraeger, Wind Lake, WI (US)

(21) Appl. No.: 14/845,965

(22) Filed: Sep. 4, 2015

Related U.S. Application Data
(63) Continuation-in-part of application No. 14/546,510, filed on Nov. 18, 2014, now abandoned.
(60) Provisional application No. 61/905,793, filed on Nov. 18, 2013.

(51) Int. Cl. A23G 3/54; A23G 1/54

(52) U.S. Cl. CPC A23G 3/54; A23G 1/54

(57) ABSTRACT

An improved s'more-like food product allows the user to achieve the same taste profile as a conventional s'mores food product while greatly simplifying the preparation of the food product by the user. Edible wraps are utilized to further enhance the eating experience.

This application is a continuation-in-part of U.S. patent application Ser. No. 14/546,510 files Nov. 18, 2014; which claims the benefit of U.S. Provisional Application No. 61/905,793, filed Nov. 18, 2013. The subject matter of each application is incorporated herein by reference.

### FIELD OF THE INVENTION

The present invention relates generally to food, food products and edible food holders. More specifically, the present invention relates to a food product configuration which improves the experience of eating roasted/toasted marshmallows.

### BACKGROUND OF THE INVENTION

Food and food products are well known and exist in a wide variety of ethnic and cultural combinations of food ingredients. One food product that can trace its roots to the traditional American “camp-out” is the s'more. A s'more is typically a food product comprised of chocolate, marshmallow and graham cracker elements. Most usually, a marshmallow is heated by using a stick or other implement to position the marshmallow in close proximity to the heat of a campfire. Once suitably warmed and somewhat fluid on its inside, the heated marshmallow is placed on top of a flat piece of chocolate, such as a portion of a chocolate bar, the chocolate piece being positioned atop a first graham cracker portion. A second graham cracker portion is then placed on top of the marshmallow and the graham cracker portions are squeezed together to form the s'mores food product, which is then ready to be consumed. In a traditional camp-out s'more, the graham cracker works as a heat retardant, an aspect of which is utilized in the food product and method of the present invention. Without it, the other s'more components would be difficult, if not impossible, to consume.

In the view of this inventor, the traditional s'mores product and the s'more-making process have several downsides to them. Perhaps most importantly is the fact that the traditional s'mores food product is messy to eat. This is primarily due to the fact that the melted marshmallow and chocolate bar often ooze out from between the graham cracker portions. The s'more-like food product can also be messy to eat because the graham cracker breaks. In some instances, the marshmallow element is not heated sufficiently to adequately melt the chocolate piece which can diminish the mouth-feel of the s'more-like food product for the user. Further, preparation for making the traditional s'mores food product often results in the user under-buying or over-buying the component parts of the s'mores food product—too much graham cracker, too little chocolate bar, etc. Also, and because the s'mores food product is typically a camp-side confection, preparation of the product is done in dimly-lit conditions which makes assembly difficult as well.

In the experience of this inventor, there is a need for an improved s'more-like food product that would eliminate the problems mentioned above. There is also a need to provide the user with a much simplified way of making the final edible s'mores product in the field.

### SUMMARY OF THE INVENTION

In accordance with the foregoing, the present invention provides an improved s'more-like food product which allows the user to achieve the same taste profile as a conventional s'mores food product while greatly simplifying the preparation of the food product by the user. In the improved s'more-like food product of the present invention, the s'more-like food product is pre-made such that it has much the same properties of a tortilla or soft-taco shell, but is made from components/ingredients of traditional s'mores. It then may effectively receive a hot, roasted marshmallow to create an improved roasted marshmallow and s'more experience.

More specifically, the s'more wrap is an edible wrap made of marshmallow, coated on both sides with crushed graham cracker, with melted chocolate added in strategic spots to one side of the wrap. The chocolate is strategically placed so that when the wrap is folded around a “medium-sized” commercial marshmallow, much as a soft taco shell is traditionally folded around taco components, the chocolate contacts the heated, roasted marshmallow so that it melts the chocolate.

The s'more-wrap has the basic appearance of a traditional wrap or flour tortilla in that it is thin (about one-eighth inch thick) and round, with a diameter of about four inches to fully provide a safe, clean experience when used with a medium-sized commercial marshmallow. Such marshmallows are very standard. They are presently almost all made by one of two manufacturers—Kraft Foods or Doumak, Inc—and are about one and one-quarter inch in height and diameter prior to heating, which expands them slightly.

### BRIEF DESCRIPTION OF THE DRAWINGS

FIG. 1 is a front and top perspective view of the improved s'more-like food product in accordance with the present invention.

FIG. 2 is a cross-sectioned side elevational view of the improved s'more-like food product taken along line 2-2 of FIG. 1.

FIG. 3 is a front and top perspective view showing the improved s'more-like food product placed into the edible wrap.

FIG. 4 shows two alternative embodiments of the s'more-like food product.

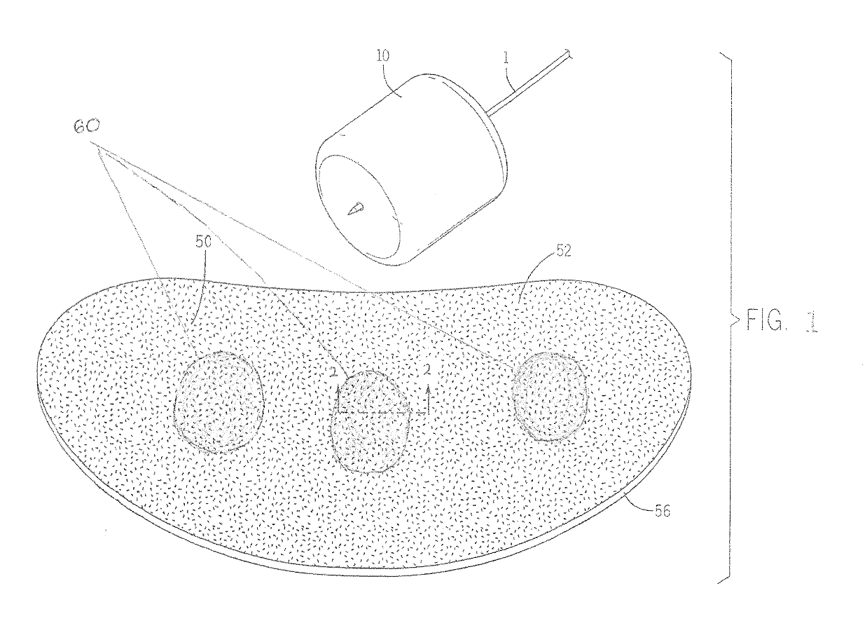

### DETAILED DESCRIPTION OF THE INVENTION

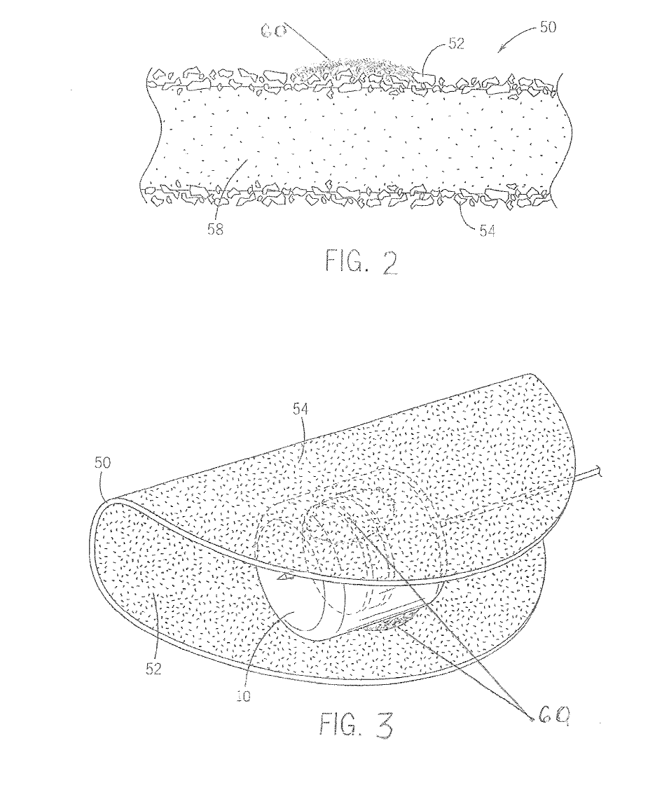

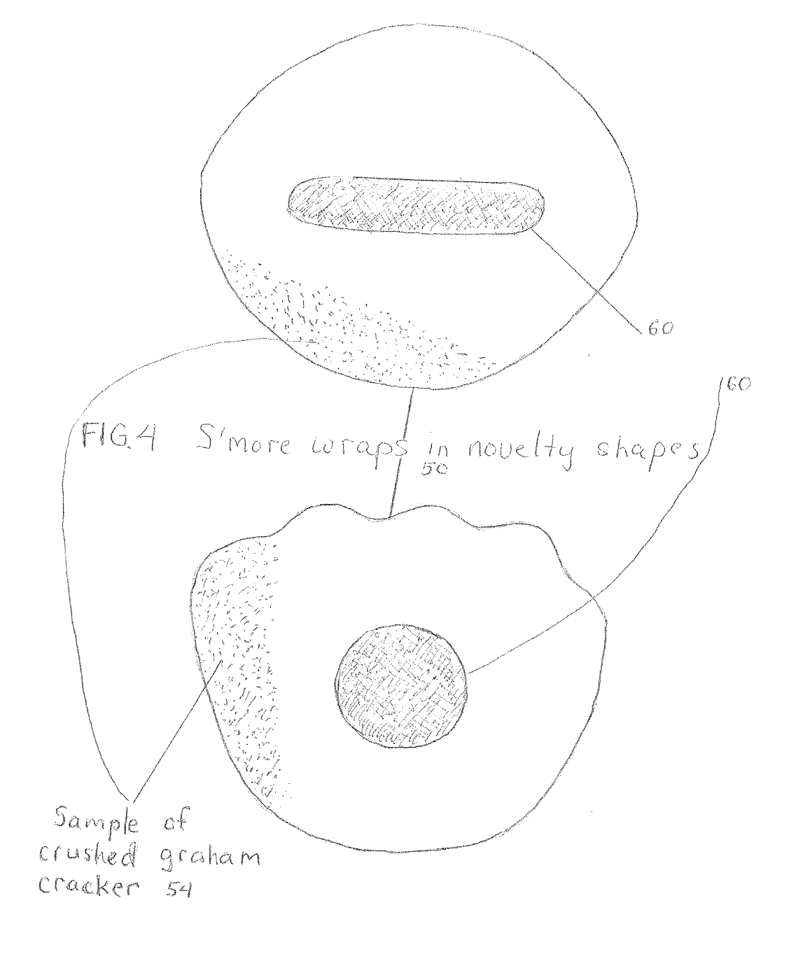

The marshmallow component 58 of the s'more wrap 50 is about one-eighth of an inch thick. See FIG. 2. It is denser than commercial marshmallow when aerated less. It can be produced in the configurations in the present invention using commercial marshmallow aeration/dispensing equipment, in a similar method to that employed by Chattanooga Bakery, manufacturers of the popular “Moon Pies” commercial desserts, in creating the marshmallow layer component of Moon Pies. It can also be created with aeration/extrusion equipment as employed by commercial marshmallow manufacturers.

Whether made by hand or with automation equipment, the marshmallow component 58 is made in much the same way traditional marshmallow is made. The ingredients may be identical.

Marshmallow is traditionally made, in part, by cooking sugar and corn syrup to at least “firm ball stage” of 244 degrees, mixing the sugar and corn syrup with water and a gelatin, then aerating it as it cools. The main difference in making marshmallow for s'more wraps, when hand-made, is that the marshmallow is poured while it is hotter, denser/less aerated, and still a liquid.

The liquid marshmallow is poured or otherwise dispensed directly onto crushed graham cracker 54. While the raw marshmallow is still hot and sticky, crushed graham cracker is also applied to the “up” or “top” side 52. When ample crushed graham cracker is used, this method results in complete, or nearly complete, coverage of the marshmallow, which allows the graham cracker to be its most effective. The wrap is then left to cool and firm up.

As a final step, melted chocolate 60 is added in strategic areas on one side 52 of the wrap 50. The chocolate 60 subsequently hardens as it cools.

To create s'more wraps of an effective size by producing marshmallow in a traditional method and then later “slicing thin” marshmallow off of the requisite “marshmallow loaf,” is quite impractical by any method known to the inventor, as the marshmallow has tremendous “give,” as opposed to being firm, thereby preventing straight cuts. Non-straight cuts result in inconsistent thickness. Also, marshmallow residue gums the cutting instrument. It is true that marshmallows are mass produced in a “simultaneous guillotine” method through extruded “ropes” of marshmallow, however, they are not sliced thin. They are sliced in thick widths relative to their height. Also, effectively applying crushed graham cracker to already “set up” marshmallow is impractical without an additional adhering agent, which may change the taste and/or texture profile from a traditional s'more.

In the present invention, the crushed graham cracker serves as a heat retardant on the side 52 that will receive the hot, roasted marshmallow 10, which prevents the roasted marshmallow 10 from melting through the wrap 50. The crushed graham cracker on the opposite side 54 serves to prevent the marshmallow from making the user's hand sticky.

In practice, the strategically placed chocolate 60 comes in direct contact with the heated marshmallow 10, thereby melting the chocolate 60 as intended.

In practice, when a roasted marshmallow 10 is introduced to the s'more wrap, the roasted marshmallow flavor dominates the raw marshmallow flavor of the s'more wrap 50 to complete a s'more-like taste experience.

While the s'more wrap must be a minimum of about four inches in diameter to be sufficiently effective when employed to receive a heated, and therefore expanded, medium-sized commercial marshmallow, it need not be exactly round. The inventors have produced the present invention in mostly round, but slightly baseball-mitt and football shapes; roasting marshmallows is a common tailgating activity at baseball and football games.

The present invention may be altered slightly, such as to include chocolate flavoring and appearance in the marshmallow component, or adding other ingredients in the pre-made product, such as peanut butter.

S'more wraps are a cleaner, more convenient and safer way to enjoy roasted marshmallows and to create a s'more-like experience.

The mess of traditional s'mores is a significant problem. Gooey marshmallow is usually a simple annoyance on fingers but when sufficiently hot it can burn skin, and is a problem when on clothes/scout uniforms, furniture, carpet, etc. Spilled chocolate can stain.

Hot, sharp skewers with hot roasted marshmallows can be dangerous. S'more wraps help minimize this danger. S'more wraps are a better “catcher” of roasted marshmallows than traditional graham crackers in that they are larger and flexible, whereby they can easily be made into more of a cradle to better catch and grasp roasted marshmallows. Consider that often the roasted marshmallow is about to fall off its skewer, which can lead the skewer operator making a sudden panicked move with the hot marshmallow, whereby a superior catcher than a graham cracker is useful.

In the inventor's experience, traditional s'mores consumers often rush eating their s'mores because of the anticipated mess. The s'more wrap allows the consumer to savor the experience, as they have confidence that they won't spill messy components.

When marshmallows are included with s'more wraps, there is no guesswork for the consumer as to what amount of each component of traditional s'mores to purchase—no double-buying or forgetting a component.

The chocolate melts better with s'more wraps than with thick chocolate bar pieces, as are usually employed when traditional s'mores are made.

It is often dark around campfires. The s'more wrap, being a single entity with marshmallow, graham cracker and chocolate, aids in creating a s'more-like experience in the dark, whereby it may be difficult to find multiple individual components.

The s'more wrap user can easily add their own components to their wrap, such as chocolate chips, peanut butter, cookie bits, syrup, bananas, whipped crème, etc, more easily and cleanly than they can with graham crackers as the “outside” component, as with traditional s'mores.

S'more wraps are flexible and therefore not prone to breaking as can easily happen with graham crackers. This is also a practical problem when traditional s'more components are sold together—s'more “kits.”

The traditional methods of roasting marshmallows by themselves or as a component of traditional s'mores have significant drawbacks: Directly off the skewer is messy and potentially dangerous, especially with children when the skewer is hot and sharp. Off of a plate can be very messy and wasteful, especially without utensils, as much of the marshmallow sticks to the plate. Off of graham crackers is usually messy, especially when the marshmallow oozes over the edge of the graham crackers, and/or the graham cracker(s) break.

Alternative wraps have proved inferior in practice: Traditional commercial tortillas (usually flour-based) or sweetened flour tortillas are effective to grasp a roasted marshmallow off a skewer but radically alter/worsen the flavor of the roasted marshmallow.

Edible s'more wraps solve these problems.

In summary, s'more wraps are a unique and delicious stand-alone product. When used to clutch and receive a hot, roasted marshmallow off of a skewer, they solve multiple problems.

The details of the invention having been disclosed in accordance with the foregoing.

I claim:

1. An edible wrap food product comprising:
a marshmallow layer having a top surface and a bottom surface;
crushed graham cracker pieces applied to cover the top surface and to cover the bottom surface of the marshmallow layer;
at least one deposit of chocolate applied to one side of the graham cracker pieces and marshmallow layer;
wherein a roasted marshmallow can be placed on top of the at least one deposit of chocolate and the edible wrap food product can be folded over thereby capturing the marshmallow within the edible wrap food product.

2. The edible wrap food product of claim 1 wherein the at least one deposit of chocolate is deposited at various points on the food product surface.

3. The edible wrap food product of claim 1 wherein the edible wrap is formed in the shape of a tortilla.

4. The edible wrap food product of claim 1 wherein the edible wrap is formed from ingredients that match the taste profile of a conventional s'mores food product.

5. The edible wrap food product of claim 1 wherein the food product comprises other taste profiles and colors.

6. The edible wrap food product of claim 1 wherein the graham cracker covered marshmallow layer is formed in a variety of shapes to include: standard geometric shapes of: a round shape; a square shape; an oval shape; a pentagonal shape; a hexagonal shape; an octagonal shape; the novelty shapes of: a baseball mitt shape; a baseball “home plate” shape; a football shape; a football helmet shape, etc—especially shapes in-keeping with themes of events where marshmallows are traditionally roasted.

7. The edible wrap food product of claim 6 wherein the deposited chocolate is in shapes to enhance the appearance of any novelty shape in the shape of football seams on a football, a logo on a football helmet, a baseball in a baseball mitt, etc.
